(19) United States
(12) Patent Application Publication
(10) Pub. No.: US 2015/0070598 A1
(43) Pub. Date: Mar. 12, 2015

(54) COVER WINDOW, MANUFACTURING METHOD THEREOF, AND TOUCHSCREEN INCLUDING THE SAME

(71) Applicant: SAMSUNG ELECTRO-MECHANICS CO., LTD., Suwon (KR)

(72) Inventors: Jae Hun KIM, Suwon (KR); Seong Ho Kim, Suwon (KR); Jin Uk Lee, Suwon (KR)

(73) Assignee: SAMSUNG ELECTRO-MECHANICS CO., LTD., Suwon (KR)

(21) Appl. No.: 14/080,303

(22) Filed: Nov. 14, 2013

(30) Foreign Application Priority Data
Sep. 6, 2013 (KR) 10-2013-0107547

(51) Int. Cl. G06F 1/16; B32B 37/06; B32B 37/18; B32B 38/00; B32B 38/10; B32B 38/08

(52) U.S. Cl. CPC G06F 1/169; B32B 38/10; B32B 38/08; B32B 37/18; B32B 38/145; B32B 37/06; B32B 2310/0418; B32B 2309/02; B32B 2457/208
USPC 349/12; 156/101; 216/26; 428/173

(57) ABSTRACT

There are provided a cover window including: a first glass panel; a printed portion formed in a concave part of one surface of the first glass panel; and a second glass panel bonded to one surface of the first glass panel, a manufacturing method thereof, and a touchscreen including the same.

### CROSS-REFERENCE TO RELATED APPLICATION

This application claims the benefit of Korean Patent Application No. 10-2013-0107547 filed on Sep. 6, 2013, with the Korean Intellectual Property Office, the disclosure of which is incorporated herein by reference.

### BACKGROUND OF THE INVENTION

1. Field of the Invention

The present invention relates to a cover window, a manufacturing method thereof, and a touchscreen including the same.

2. Description of the Related Art

A touch sensing apparatus such as a touchscreen, a touch pad, or the like, an input apparatus attached to a display apparatus to provide an intuitive data input method to a user, has recently been widely used in various electronic devices such as cellular phones, personal digital assistants (PDA), navigation devices, and the like. Particularly, as demand for smartphones has recently increased, the use of touchscreens capable of providing various data input methods in a limited form factor has continually increased.

Touchscreens used in portable devices may be mainly divided into resistive type touchscreens and capacitive type touchscreens, according to a method of sensing a touch input. Among them, capacitive type touchscreens have advantages in that they have a relatively long lifespan and may easily allow for the implementation of various data input methods and gestures, such that the use thereof has correspondingly increased. Particularly, capacitive type touchscreens may more easily allow for the implementation of a multi-touch interface, as compared with resistive type touchscreens, such that they are widely used in devices such as smartphones, and the like.

Capacitive type touchscreens include a plurality of electrodes having a predetermined pattern and defining a plurality of nodes in which changes in capacitance are generated by a touch input. In the plurality of nodes distributed on a two-dimensional plane, changes in self-capacitance or mutual-capacitance change are generated by touches. Coordinates of touches may be calculated by applying a weighted average method, or the like, to the changes in capacitance generated in the plurality of nodes.

A touchscreen used in the touchscreen is divided into an active region for receiving touches by a user and a bezel region for visually shielding wiring electrodes, or the like, wherein the bezel region is formed by depositing a predetermined printed region on a cover window to which touches is applied. However, in the case in which the predetermined printing region is deposited on the cover window, a step portion may be generated, such that air bubbles may be generated in an adhesive layer adhered to the cover window and an electrode formed on the cover window may be short-circuited.

The following Related Art Document (Patent Document 1), which relates to a touchscreen and a manufacturing method thereof, discloses content in which a cover lens is partially etched and a decoration region is formed in the etched region in order to remove a step portion due to the decoration region formed in a cover lens, but does not disclose content in which a step portion, formed due to an error inevitably caused by a manufacturing process is removed.

### RELATED ART DOCUMENT

(Patent Document 1) Korean Patent Laid-Open Publication No. 10-2013-0061252A

### SUMMARY OF THE INVENTION

An aspect of the present invention provides a cover window in which a step portion due to an error inevitably caused by a manufacturing process is removed by burying a printing region in one surface of one glass substrate and bonding one surfaces of one glass substrate and another glass substrate to each other, a manufacturing method thereof, and a touchscreen including the same.

According to an aspect of the present invention, there is provided a cover window including: a first glass panel; a printed portion formed in a concave part of one surface of the first glass panel; and a second glass panel bonded to one surface of the first glass panel.

The concave part and the printed portion may have the same thickness as each other.

One surfaces of the first glass panel and the second glass panel may be thermal-fusion-bonded to each other.

One surfaces of the first glass panel and the second glass panel may be thermal-fusion-bonded to each other at a temperature of 550° C.

One surfaces of the first glass panel and the second glass panel may be double-side-bonded to each other using an anti-scattering film.

The concave part may be formed by etching one surface of the first glass panel according to a predetermined mask pattern.

The concave part may be formed by etching one surface of the first glass panel with a hydrofluoric acid aqueous solution.

The cover window may further include a reinforcing layer formed by subjecting surfaces of the first and second glass panels bonded to each other to a chemical reinforcing treatment.

The reinforcing layer may be formed by subjecting the surfaces of the first and second glass panels bonded to each other to the chemical reinforcing treatment using KNO₃ at a temperature of 550° C.

According to another aspect of the present invention, there is provided a touchscreen including: a substrate; a plurality of electrodes formed on one surface or both surfaces of the substrate; and the cover window as described above bonded to any one surface of the substrate on which the plurality of electrodes are formed and a surface facing the any one surface of the substrate.

According to another aspect of the present invention, there is provided a touchscreen including: the cover window as described above; a plurality of first electrodes formed on the cover window; and a plurality of second electrodes insulated from the plurality of first electrodes.

According to another aspect of the present invention, there is provided a manufacturing method of a cover window, including: forming a concave part having a predetermined thickness in one surface of a first glass panel; forming a predetermined printed portion in the concave part; and bonding one surfaces of the first glass panel and a second glass panel to each other.

The forming of the concave part may include: depositing a predetermined photo-resist on the first glass panel; exposing a predetermined region of the photo-resist to form a mask pattern; and etching the first glass panel according to the mask pattern.

In the etching of the first glass panel, the first glass panel may be etched using a hydrofluoric acid aqueous solution.

In the forming of the predetermined printed portion, the predetermined printed portion may be formed in the concave part using a screen printing method or an inkjet printing method.

In the bonding of the one surfaces of the first glass panel and the second glass panel to each other, one surfaces of the first glass panel and the second glass panel may be thermal-fusion-bonded to each other.

One surfaces of the first glass panel and the second glass panel may be thermal-fusion-bonded to each other at a temperature of 550° C.

In the bonding of the one surfaces of the first glass panel and the second glass panel to each other, one surfaces of the first glass panel and the second glass panel may be double-side-bonded to each other using an anti-scattering film.

The manufacturing method of a cover window may further include subjecting surfaces of the first and second glass panels bonded to each other to a chemical reinforcing treatment.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an appearance of an electronic device including a touchscreen according to an embodiment of the present invention;

FIG. 2 is a front view of the touchscreen according to the embodiment of the present invention;

FIGS. 3 through 6 are cross-sectional views of touchscreens according to various embodiments of the present invention;

FIGS. 7 and 8 are views showing a cover window according to the embodiment of the present invention; and

FIGS. 9A through 9G are views showing a manufacturing process of the cover window according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

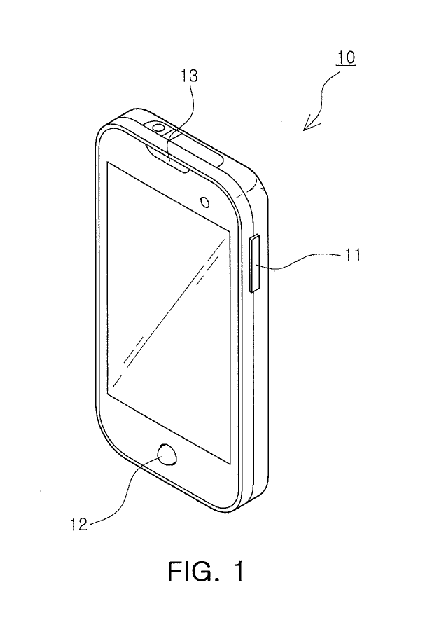

FIG. 1 is a perspective view showing an appearance of an electronic device including a touchscreen according to an embodiment of the present invention.

Referring to FIG. 1, the electronic device 10 according to the present embodiment may include a display apparatus 11 for outputting an image, an input unit 12, an audio unit 13 for audio output, and a touchscreen apparatus integrated with the display apparatus 11, wherein the touchscreen apparatus may include a touchscreen.

As shown in FIG. 1, in the case of a mobile device, the touchscreen apparatus may be generally provided in the state in which it is integrated with the display apparatus and needs to have light transmissivity high enough to transmit a screen displayed by the display apparatus. Therefore, the touchscreen apparatus may be implemented by forming an electrode on a transparent substrate using a material having electrical conductivity. A wiring electrode connected to the electrode formed using the conductive material may be disposed in a bezel region of the display apparatus and be visually shielded by the bezel region.

Since it is assumed that the touchscreen apparatus is operated in a capacitive scheme, the touchscreen apparatus may include a plurality of electrodes having a predetermined pattern. In addition, the touchscreen apparatus may include a capacitance sensing circuit detecting changes in capacitance generated in the plurality of electrodes, an analog-to-digital converting circuit converting an output signal of the capacitance sensing circuit into a digital value, a calculating circuit judging a touch input using the data converted into the digital value, and the like.

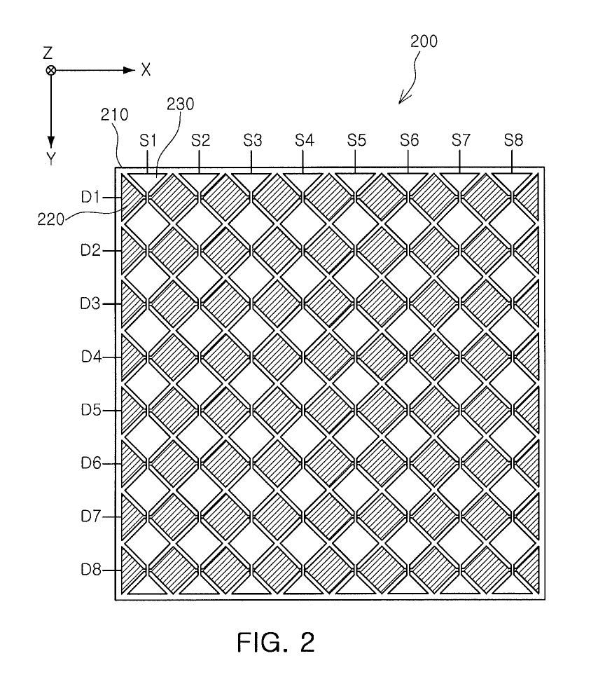

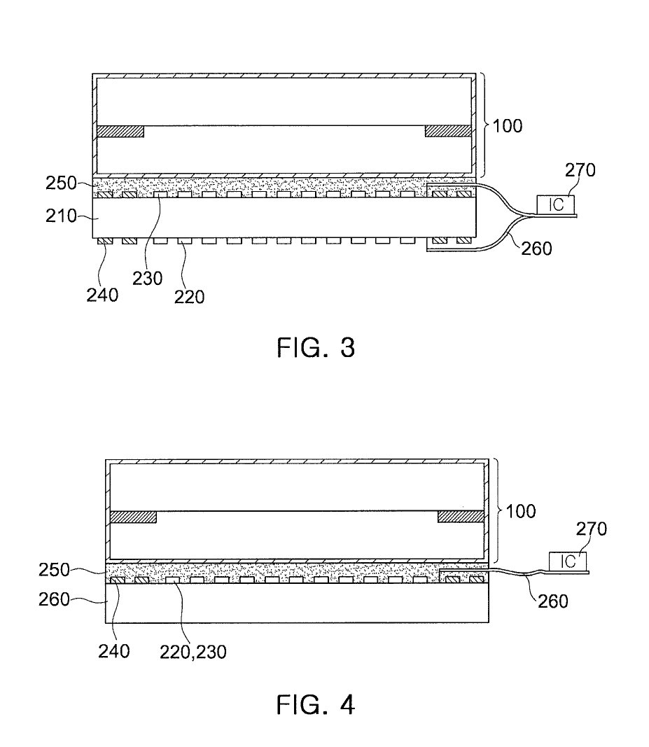

FIG. 2 is a front view of the touchscreen according to the embodiment of the present invention; and FIGS. 3 through 6 are cross-sectional views of touchscreens according to various embodiments of the present invention.

Referring to FIGS. 2 through 5, the touchscreen 200 according to the present embodiment may include a substrate 210, a plurality of electrodes 220 and 230 provided on the substrate 210, and a cover window 100 attached to a front surface of the substrate 210. Here, an adhesive layer 250 adhering the substrate 210 and the cover window 100 to each other may be formed of an optical clear adhesive (OCA), but is not limited thereto.

Each of the plurality of electrodes 220 and 230 may be electrically connected to wiring electrodes 240 of a flexible circuit board 260 attached to one end of the substrate 210 through wirings and bonding pads. The flexible circuit board 260 may have a controller integrated circuit 270 mounted thereon to detect sensing signals generated in the plurality of electrodes 220 and 230 and judge touch inputs from the sensing signals.

The substrate 210 may be a transparent substrate on which the plurality of electrodes 220 and 230 are to be formed. Therefore, the substrate 210 may be formed of a material such as a polyethylene terephthalate (PET) film, a polycarbonate (PC) film, a polyethersulfone (PES) film, a polyimide (PI) film, a polymethlymethacrylate (PMMA) film, a cyclo-olefin polymer (COP) film, soda glass, or tempered glass.

The plurality of electrodes 220 and 230 may be formed on one surface or both surfaces of the substrate 210. Although the plurality of electrodes 220 and 230 are shown as having rhomboid or diamond shaped patterns in FIG. 2, they may have various polygonal patterns such as rectangular patterns, triangular patterns, or the like. The plurality of electrodes 220 and 230 having conductivity may be formed of a material such as indium tin oxide (ITO), indium zinc oxide (IZO), zinc oxide (ZnO), carbon nanotubes (CNT), or a graphene and be formed by implementing invisible conductive fine lines using any one of Ag, Al, Cr, Ni, Mo, and Cu, or alloys thereof.

The plurality of electrodes 220 and 230 may include first electrodes 220 extended in an X axis direction and second electrodes 230 extended in a Y axis direction. In the case in which the first and second electrodes 220 and 230 are provided on both surfaces of the substrate 210 (See FIG. 3) or both of the first and second electrodes 220 and 230 are provided on different substrates 210 (See FIGS. 4 and 5), a predetermined insulating layer may be partially formed at intersection points between the first and second electrodes 220 and 230. Unlike this, the first and second electrodes 220 and 230 may be provided and intersect with each other on different substrates 210.

An apparatus electrically connected to the plurality of electrodes 220 and 230 to sense touches may detect the changes in capacitance generated in the plurality of electrodes 220 and 230 by touches and sense touches from the detected changes in capacitance. The first electrodes may be connected to channels defined as D1 to D8 in the controller integrated circuit to receive predetermined driving signals, and channels defined as S1 to S8 may be connected to the second electrodes 230 and be used to detect the changes in capacitance generated between the first and second electrodes 220 and 230. Here, the controller integrated circuit 270 may judge touches using the changes in capacitance as a sensing signal.

Unlike the embodiment described above with reference to FIGS. 3 through 5, the plurality of electrodes 220 and 230 may be provided on the cover window 100. Here, in the case in which the plurality of electrodes 220 and 230 are provided on one surface of the cover window 100, a predetermined insulating layer may be partially formed at intersection points between the first and second electrodes 220 and 230.

In addition, as shown in FIG. 6, a predetermined insulating layer 215 may cover the second electrode 230, and the first electrodes 220 may be provided on one surface of the insulating layer 215. The insulating layer 215 may be formed of an inorganic material including one of SiO₂, Al₂O₃, Ta₂O₅, Nb₂O₅, Si₃N₄, and TiO₂, an organic material including one of PGMEA and acryl, or a transparent film including one of PET, PC, PES, PI, PMMA, and COP.

In the embodiment shown in FIGS. 2 through 6, in a region in which the wiring electrodes 240 connected to the plurality of electrodes 220 and 230 are provided, a predetermined printing region for visually shielding the wiring electrodes 240 generally formed of a non-transparent metal material may be provided on the cover window. Hereinafter, a cover window 100 according to the embodiment of the present invention will be described in detail.

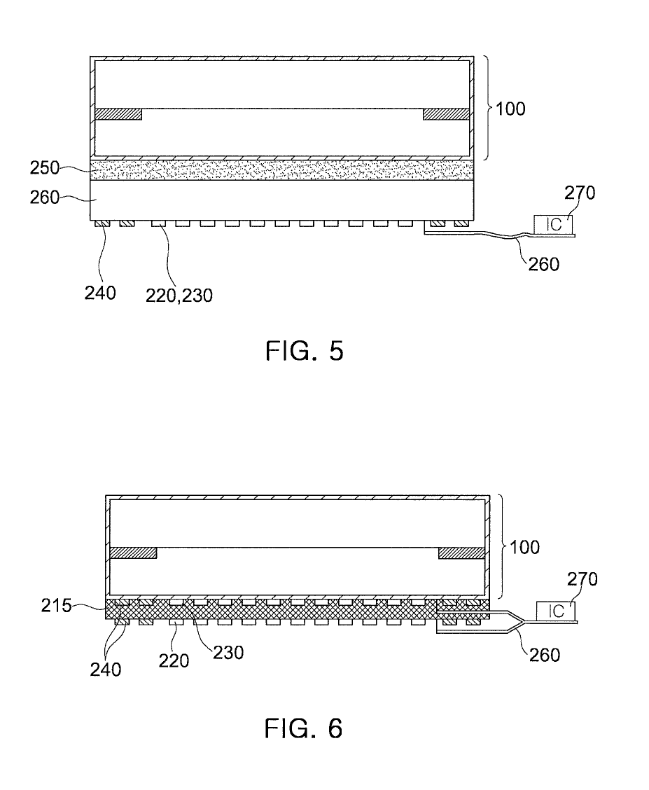

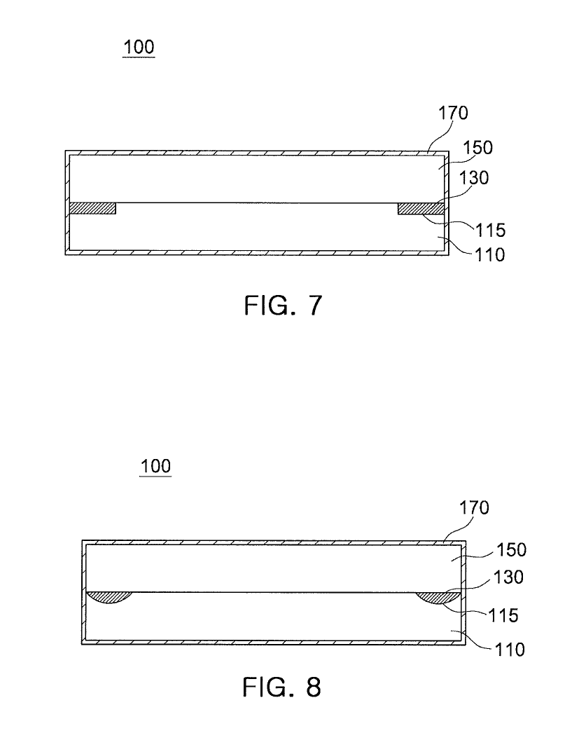

FIGS. 7 and 8 are views showing a cover window according to the embodiment of the present invention.

The cover window 100 may be disposed at the outermost position of the touchscreen to serve to receive a touch input from a contact object such as a finger, or the like. Referring to FIG. 7, the cover window 100 according to the present embodiment may include a first glass panel 110, a printed portion 130 buried in the first glass panel 110, and a second glass panel 150 bonded to the first glass panel 110. In addition, the cover window 100 according to the present embodiment may further include a reinforcing layer 170. The first and second glass panels 110 and 150 may be tempered glass.

As described above, the predetermined printing region may be provided on the cover window for visually shielding the wiring electrodes formed of a non-transparent metal material unlike the plurality of electrodes generally formed of a transparent material or an invisible material.

The printing region may be generally formed to have a thickness of 5 to 10 μm. In the case in which the printing region is formed on an upper surface of the cover window rather than being buried in the cover window, a step portion may be generated between the printing region and the cover window.

Here, in the case in which a predetermined adhesive layer or insulating layer is formed on the cover window so as to cover the printing region, air bubbles may be generated in the adhesive layer due to the step portion. In addition, at the time of printing a plurality of insulating layers so as to cover a thickness of the printing region, printing quality is decreased and turbidity is increased, such that optical characteristics may be deteriorated.

According to the present embodiment, the predetermined printing region may be buried in the cover window to prevent the step portion from being generated between the cover window and the predetermined printing region.

More specifically, the first glass panel 110 may include a concave part 115 formed in one surface thereof, and a printed portion 130 may be buried in the concave part 115. Here, in order to prevent the step portion due to the printed portion 130, the concave part 115 may have the same thickness as that of the printed portion 130. As shown in FIGS. 7 and 8, the concave part 115 may have a rectangular shape or a semicircular shape. However, the shape of the concave part 115 is not limited to the shapes shown in FIGS. 7 and 8.

A color of the printed portion 130 may be black, white, gold, red, green, yellow, gray, purple, brown, blue, or a combination thereof. Materials capable of forming the printed portion 130 so as to have the above-mentioned respective colors will be described below in detail.

First, when a carbon based material (a graphene oxide or a diamond line carbon (DLC)), a chrome based oxide (CrO or CrO₂), a copper based oxide (CuO), a manganese based oxide (MnO₂), a cobalt based oxide (CoO), a sulfide (CoS₂ or Co₃S₄), a nickel based oxide (Ni₂O₃), HgTe, YBa₂Cu₃O7, MoS₂, RuO₂, PdO, InP, SnO, TaN, TaS₂, or the like, is used, the printed portion 130 may be formed so as to have the black color.

In addition, when a titanium based oxide (TiO₂), an aluminum based oxide (Al₂O₃), a magnesium based oxide (MgO), a sodium based oxide (Na₂O), a lithium based oxide (Li₂O), a beryllium based oxide (BeO), a magnesium based sulfide (MgS), MgF₂, MgCo₃, ZnO, ZnS, KNO₃, KCl, KOH, Ga₂O₃, RbCl, RbF, BaTiO₃, BaSO₄, BaCl₂, BaO, Ba(NO₃)₂, BaCO₃, BaOH, BaB₂O₄, SrTiO₃, SrCl₂, SrO, Y₂O₃, YCl₃, YF₃, ZrO₂, ZrCl₄, ZrF₄, Nb₂O₅, NbOCl₃, Mo(CO)₆, CdCl₂, InCl₃, SnO₂, Sb₂O₃, CsI, CsCl, CsF, Ta₂O₅, TaCl₅, TaF₅, or the like, is used, the printed portion 130 may be formed so as to have the white color.

Further, when a titanium based nitride (TiN), or the like, is used, the printed portion 130 may be formed so as to be gold, and when a copper based oxide (Cu₂O), an iron based oxide (Fe₂O₃), ZnTe, a Tris(bipyridine)ruthenium chloride, PdCl₂, or CdSe, or the like, is used, the printed portion 130 may be formed so as to be red.

In addition, in the case that a chrome based oxide (Cr₂O₃), MnO, NiO, MoCl₅, BiI₃, or the like, is used, the printed portion 130 may be formed so as to have the green color, and when a sodium based oxide (Na₂O₂), K₂O, CaO, V₂O₅, ZnSe, GaN, GaP, Rb₂O, NbCl₅, CdS, CdI₂, In₂O₃, Sb₂O₅, Cs₂O, WO₃, Bi₂O₃, or the like, is used, the printed portion 130 may be formed so as to be yellow.

Further, when MgB₂, Si₃N₄, RbOH, BaO₂, ZrC, NbO, MoSi₂, WC, Bi₂Te₃, or the like, is used, the printed portion 130 may be formed so as to be gray, and when Ru(acac)₃, or the like, is used, the printed portion 130 may be formed so as to be purple.

In addition, when Pd(O₂CCH₃)₂, CdO, InSb, or a tantalum carbide, or the like, is used, the printed portion 130 may be formed so as to be brown, and when WCl₆, or the like, is used, the printed portion 130 may be formed to be blue.

In addition, when a combination of the above-mentioned materials is used, the printed portion 130 may be formed to have a color corresponding to a combination of at least two of black, white, gold, red, green, yellow, gray, purple, brown, and blue.

Even in the case in which the concave part 115 is formed in the first glass panel 110 and the printed portion 130 is buried in the concave part 115, a fine step portion may be generated due to an error inevitably caused by a manufacturing process. However, according to the present embodiment, one surface of the first glass panel 110 in which the concave part 115 is formed may be bonded to the second glass panel 170 to remove an influence of the fine step portion. In the case, one surface of the first glass panel 110 may be thermal-fusion-bonded to the second glass panel 170, wherein the thermal-fusion-bonding may be performed at a temperature of 550° C. In addition, the first and second glass panels 110 and 170 may be double-side-bonded to each other using an anti-scattering film.

Then, the first and second glass panels 110 and 150 bonded to each other may be subjected to a chemical reinforcing treatment, such that the reinforcing layer 170 may be formed on surfaces of the first and second glass panels 110 and 150 bonded to each other. More specifically, the reinforcing layer 170 may be formed by subjecting the first and second glass panels 110 and 150 to the chemical reinforcing treatment using KNO3 at a temperature of 550° C. The reinforcing layer 170 may be formed over the entire surface of the cover window 100 to secure strength.

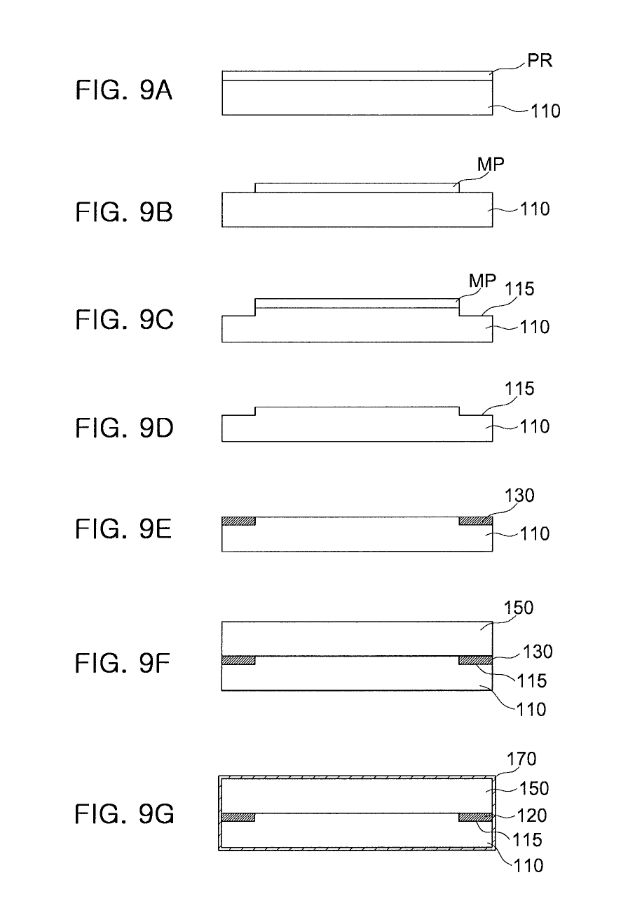

FIGS. 9A through 9G are views showing a manufacturing process of the cover window according to the embodiment of the present invention. Hereinafter, the manufacturing process of the cover window according to the present embodiment will be described with reference to FIGS. 9A through 9G.

A photo-resist PR may be deposited on one surface of the first glass panel 110 (See FIG. 9A), and exposure may be performed to form a mask pattern MP (See FIG. 9B). Then, one surface of the first glass panel 110 on which the mask pattern MP is formed is etched using a hydrofluoric acid aqueous solution, such that the concave part 115 may be formed in one surface of the first glass panel 110 (See FIG. 9C). Here, although the case in which the concave part 115 has a rectangular shape has been shown in FIG. 9C, the concave part 115 may also have a semicircular shape as described above.

Then, the mask pattern MP remaining on one surface of the first glass panel 110 may be stripped using a stripper or the like (please see FIG. 9D), and the printed portion 130 having the same thickness as that of the concave part 115 may be formed in the concave part 115 formed in the first glass panel 110 using a printing method such as a screen printing method, an inkjet printing method, or the like (please see FIG. 9E). In this case, a fine step portion may be generated between the first glass panel 110 and the printed portion 130 due to an error inevitably caused in a manufacturing process. In order to remove the fine step portion, one surfaces of the first glass panel 110 and the second glass panel may be bonded to each other (please see FIG. 9F). The first and second glass panels 110 and 150 bonded to each other are subjected to the chemical reinforcing processes, such that the reinforcing layer 170 may be formed on the surfaces of the first and second glass panels 110 and 150 (please see FIG. 9G).

As set forth above, according to the embodiments of the present invention, the printing region is buried in one surface of one glass substrate and one surface of one glass substrate and another glass substrate are bonded to each other, whereby a step portion due to an error caused by a manufacturing process may be removed.

While the present invention has been shown and described in connection with the embodiments, it will be apparent to those skilled in the art that modifications and variations can be made without departing from the spirit and scope of the invention as defined by the appended claims.

What is claimed is:

1. A cover window comprising:
a first glass panel;
a printed portion formed in a concave part of one surface of the first glass panel; and
a second glass panel bonded to one surface of the first glass panel.

2. The cover window of claim 1, wherein the concave part and the printed portion have the same thickness as each other.

3. The cover window of claim 1, wherein one surfaces of the first glass panel and the second glass panel are thermal-fusion-bonded to each other.

4. The cover window of claim 3, wherein one surfaces of the first glass panel and the second glass panel are thermal-fusion-bonded to each other at a temperature of 550° C.

5. The cover window of claim 1, wherein one surfaces of the first glass panel and the second glass panel are double-side-bonded to each other using an anti-scattering film.

6. The cover window of claim 1, wherein the concave part is formed by etching one surface of the first glass panel according to a predetermined mask pattern.

7. The cover window of claim 6, wherein the concave part is formed by etching one surface of the first glass panel with a hydrofluoric acid aqueous solution.

8. The cover window of claim 1, further comprising a reinforcing layer formed by subjecting surfaces of the first and second glass panels bonded to each other to a chemical reinforcing treatment.

9. The cover window of claim 8, wherein the reinforcing layer is formed by subjecting the surfaces of the first and second glass panels bonded to each other to the chemical reinforcing treatment using KNO₃ at a temperature of 550° C.

10. A touchscreen comprising:
a substrate;
a plurality of electrodes formed on one surface or both surfaces of the substrate; and
the cover window of claim 1 bonded to any one surface of the substrate on which the plurality of electrodes are formed and a surface facing the any one surface of the substrate.

11. A touchscreen comprising:
the cover window of claim 1;
a plurality of first electrodes formed on the cover window; and
a plurality of second electrodes insulated from the plurality of first electrodes.

12. A manufacturing method of a cover window, comprising:
forming a concave part having a predetermined thickness in one surface of a first glass panel;
forming a predetermined printed portion in the concave part; and
bonding one surfaces of the first glass panel and a second glass panel to each other.

13. The manufacturing method of a cover window of claim 12, wherein the forming of the concave part includes:
depositing a predetermined photo-resist on the first glass panel;
exposing a predetermined region of the photo-resist to form a mask pattern; and
etching the first glass panel according to the mask pattern.

14. The manufacturing method of a cover window of claim 13, wherein in the etching of the first glass panel, the first glass panel is etched using a hydrofluoric acid aqueous solution.

15. The manufacturing method of a cover window of claim 12, wherein in the forming of the predetermined printed portion, the predetermined printed portion is formed in the concave part using a screen printing method or an inkjet printing method.

16. The manufacturing method of a cover window of claim 12, wherein in the bonding of the one surfaces of the first glass panel and the second glass panel to each other, one surfaces of the first glass panel and the second glass panel are thermal-fusion-bonded to each other.

17. The manufacturing method of a cover window of claim 16, wherein one surfaces of the first glass panel and the second glass panel are thermal-fusion-bonded to each other at a temperature of 550° C.

18. The manufacturing method of a cover window of claim 12, wherein in the bonding of the one surfaces of the first glass panel and the second glass panel to each other, one surfaces of the first glass panel and the second glass panel are double-side-bonded to each other using an anti-scattering film.

19. The manufacturing method of a cover window of claim 12, further comprising subjecting surfaces of the first and second glass panels bonded to each other to a chemical reinforcing treatment.
